(19) United States
(12) Patent Application Publication
(10) Pub. No.: US 2007/0171205 A1
(43) Pub. Date: Jul. 26, 2007

(54) Keyboard having magnet-actuted switches

(76) Inventor: Dan Alan Steinberg, Blacksburg, VA (US)

Correspondence Address: Dan Steinberg, 1507 Glade Road, Blacksburg, VA, 24060, US

(21) Appl. No.: 11/705,333

(22) Filed: Feb. 12, 2007

Related U.S. Application Data
(63) Continuation-in-part of application No. 11/339,055, filed on Jan. 24, 2006.

(30) Foreign Application Priority Data
Apr. 21, 2006 (US) PCT/US06/15029

(51) Int. Cl. G06F 3/02

(52) U.S. Cl. 345/168

(57) ABSTRACT

A text input keyboard with magnet-actuated proximity switches, and a stylus having a magnet at the tip. Each key of the keyboard has a magnet actuated switch. A key is selected by disposing the stylus magnet near the selected key and switch. The switch closes due to the magnetic field from the magnet, and the low resistance state of the switch is detected by a microprocessor. The switches can be connected in a matrix array. The proximity switches can each have a flexible ferromagnetic cantilever bendable by attraction to the magnet. The present keyboard is small and requires little power, and is well suited for use in portable electronic devices. The keyboard does not require pressing of the stylus against the keyboard, which facilitates fast typing and reduces user fatigue.

### RELATED APPLICATIONS

The present application claims priority under 35 USC 120 from copending PCT application US2006/015029 filed on Apr. 21, 2006, and copending U.S. application Ser. No. 11/339,055, filed on Jan. 24, 2006.

### FIELD OF THE INVENTION

The present invention relates generally to text input devices for portable electronic devices and computers. More specifically, the present invention relates to a miniature keyboard having a magnetic proximity switch under each key. The keys are activated by a magnet.

### BACKGROUND OF THE INVENTION

Portable electronic devices such as cell phones, personal digital assistant devices (PDAs), portable email devices and the like often require text input. Text input is necessary for instant messaging and address entry on cell phones, and for portable email devices, for example. However, portable electronic devices are often too small for a practical, full function keyboard with 30, 40 or more keys. Very small keys are too small for the fingers. Also, keys that require pressure can cause repetitive stress injury in users that use the keyboard for hours a day.

Very small pressure sensitive keys can be activated by pressing with a stylus. However, forcefully pressing the keys with a stylus greatly slows text entry and is annoying for many users.

Pressure sensitive graphical pads with text recognition, optically projected keyboard images, and flexible keyboards that can be unrolled onto a flat surface have been proposed as solutions. However, all these methods are bulky, expensive, fragile or annoying to use.

What is needed is a simple, durable, inexpensive, fast and pleasant to use device for entering text into portable electronic devices. The text input device should require very little electrical power, employ simple detection circuitry, and be very small in size. Preferably, the text entry device would not require pressing of a stylus.

### SUMMARY

The present invention provides a keyboard having a plurality of keys, and a magnet-actuated switch disposed under each key. A stylus is provided with a stylus magnet at a tip of the stylus. The stylus magnet causes a magnet-actuated switch under a selected key to change state when the magnet is moved near the selected key. Electronic circuits are provided for sensing the state of each magnet-actuated key.

Each key can have a concave region disposed over each switch, for guiding the stylus tip and magnet.

The magnet-actuated switches can be reed switches or membrane switches, for example. The magnet-actuated switches can be microfabricated (i.e. by microlithographic patterning, thin film deposition and etching). The switches can comprise flexible ferromagnetic cantilevers that are pulled upwardly by the magnetic field from the stylus magnet. When pulled upward, each ferromagnetic cantilever makes electrical contact with an elevated electrode.

Preferably, the switches are normally-open switches that are closed by the presence of the stylus magnet.

Also preferably, the strength of the stylus magnet and sensitivity of the switches are selected such that only one switch changes state when the stylus magnet is disposed on a selected key. The stylus magnet is not strong enough to cause adjacent switches to close.

The keyboard of the present invention is particularly well suited for use in small portable electronic devices such as cell phones, PDAs and the like.

### DESCRIPTION OF THE FIGURES

FIG. 1 shows a cross sectional side view of a portable electronic device with the present magnetic keyboard according to the present invention.

FIG. 2 shows a top view of a portable electronic device with the present magnetic keyboard according to the present invention.

FIG. 3 shows a close-up of the present magnetic keyboard having magnetic reed switches.

FIG. 4 shows a single magnetic reed switch in an open state.

FIG. 5 shows a single magnetic reed switch in a closed state.

FIG. 6 shows a matrix array of switches connected to keyboard controller that monitors the keyboard keys.

FIG. 7 show s a reed switch with a vertical orientation.

FIG. 8 shows a reed switch with a horizontal orientation.

FIG. 9 shows an embodiment having a ferromagnetic layer under the reed switches, and ferromagnetic yokes 53 over the reed switches.

FIG. 10 shows an embodiment in which the cover is relatively flat and the concave regions are defined by ridges.

FIGS. 11A and 11B show micromachined reed switches that can be used in the present invention.

FIG. 12 shows an alternative embodiment having horizontal flexible cantilevers. The cantilevers are bent by attraction to the stylus magnet.

FIG. 13 shows a metal foil strip having 3 flexible cantilevers. The cantilevers can bend in a direction perpendicular to the page.

FIG. 14 shows a perspective view of a metal strip (with 3 flexible cantilevers) and the stylus magnet, in isolation.

FIG. 15 shows a perspective view of a 3×3 switch array having 3 metal strips and 3 orthogonal elevated electrodes. Each metal strip has 3 flexible cantilevers. The stylus magnet is shown above the elevated electrode.

FIGS. 16A and 16B show alternative shapes for the flexible cantilever.

FIGS. 17-20 show magnetic membrane switches that can be used in the present invention.

### DETAILED DESCRIPTION

The present invention provides a magnet-actuated keyboard that can be incorporated into portable electronic devices such as PDAs and cell phones. Each key in the keyboard has an associated magnetic proximity switch (e.g. a magnetic reed switch). A user operates the keyboard with a stylus having a magnet at the tip. When the stylus magnet is moved close to a key, the corresponding proximity switch closes. A microprocessor detects which proximity switch in the keyboard is closed. The magnetic switches are passive magneto-mechanical devices and do not require bias current (e.g. unlike a Hall effect or magnetoresistive sensor). Accordingly, the present keyboard requires very little operating power, and is compatible with conventional keyboard switch detection electronics. Also, mechanical pressing with the stylus is not required to select a key. Hence, the switches are mechanically isolated from the stylus and the keyboard does not require movable mechanical elements built into the external shell of the electronic device. The present keyboard is small, simple to use and reliable.

### DEFINITIONS

Reed switch: a magnet-actuated switch having two closely-spaced, approximately parallel ferromagnetic cantilevers that make electrical contact when a magnetic field aligned with the cantilevers induces attractive magnetic moments in the cantilevers.

Magnetic membrane switch: a magnet-actuated switch having a ferromagnetic element supported by a flexible elastomeric membrane. When attracted by a magnet, the ferromagnetic element moves, causing electrodes to come into electrical contact.

Magnet-actuated switch: A mechanical electrical switch that can be opened or, more typically, closed by an applied magnetic field or magnet. Hall-effect devices, magnetoresistive (e.g. spin valve or spintronic) devices and other magnetic field sensors are not magnet-actuated switches as defined in the present specification, and are outside the scope of the appended claims.

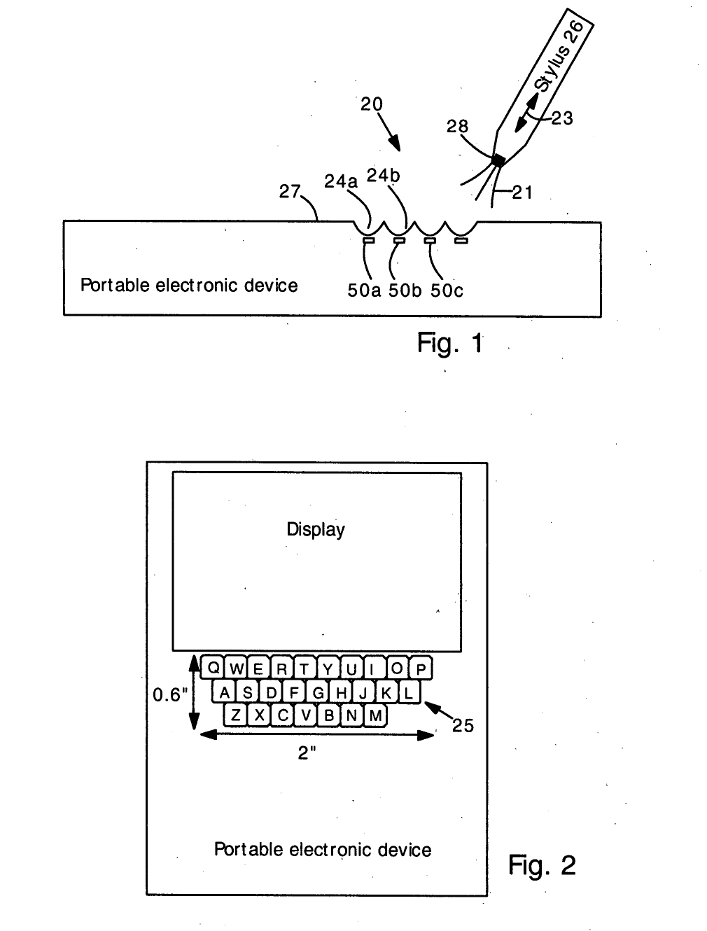

FIG. 1 shows a cross sectional view of a portable electronic device with a keyboard, according to the present invention. The portable electronic device can be a cell phone, PDA, digital camera or any other electronic device that requires text or numeric input. The device has a keyboard 20 with a plurality of keys. Each key has a magnet actuated (i.e., ‘proximity’) switch 50a 50b 50c. Preferably, each key has a concave region 24a 24b aligned with each switch 50. Each proximity switch 50 is associated with a specific text character, function or numeral. The concave regions 24 are preferably formed from a covering 27. The covering is preferably an external shell enclosing the portable electronic device. Typically, the external shell is made of a molded, rigid polymeric material, as well known in the art.

The present text input device also includes a handheld stylus 26. In the present invention, the stylus includes a stylus magnet 28. The stylus magnet 28 is disposed in a tip of the stylus. The stylus 26 can be stored in a small hole or pocket (not shown) in the portable electronic device, as known in the art. The stylus magnet 28 can hold the stylus within the hole (not shown) by magnetic attraction to a complementary magnet inside the portable electronic device.

The stylus magnet 28 has an associated magnetic field 21 capable of triggering the proximity switches 50. Preferably, the magnet 28 is a high strength magnet comprising a rare earth alloy. A magnet with small size is preferred because this tends to localize the magnetic field. Preferably, the stylus magnet 28 is oriented so that the magnetic field lines 21 are approximately parallel with an axis 23 of the stylus 26 (as shown). The magnetic pole at the stylus tip can be north or south, which produce equivalent results in the present invention.

In operation, the stylus 26 is manipulated by hand to select keys representing desired text characters. Each proximity switch 50 closes (i.e. changes to a low-resistance state) when the magnet 28 is nearby. For example, switch 50a will close when magnet 28 is moved into concave region 24a. Pressing of the stylus 26 is not required. In order to trigger a switch and select a key, the magnet 28 merely needs to be moved close to the switch. Electronic circuitry (now shown) monitors the switches 50 for low resistance indicating presence of the magnet in close proximity to one of the switches 50. The electronic circuitry provides an output indicating the keys and text characters selected by a user.

It is noted that the concave regions 24 are optional in the invention. The keys can be flat or even convex. However, concave regions 24 are preferred in the invention because they help the user to align the magnet 28 with the switches 50.

FIG. 2 shows a top view of a portable electronic device according to the present invention. The portable electronic device has an alphanumeric keyboard 25 and a display. The alphanumeric keyboard 25 can have dimensions of about 2″×1″ or 1.5″×1″ or 1″×0.5″, for example. Hence, each key can be about 0.075-0.2 inches wide and tall, for example. The keys can be rectangular as shown, or can be round, hexagonal, oval or any other convenient shape.

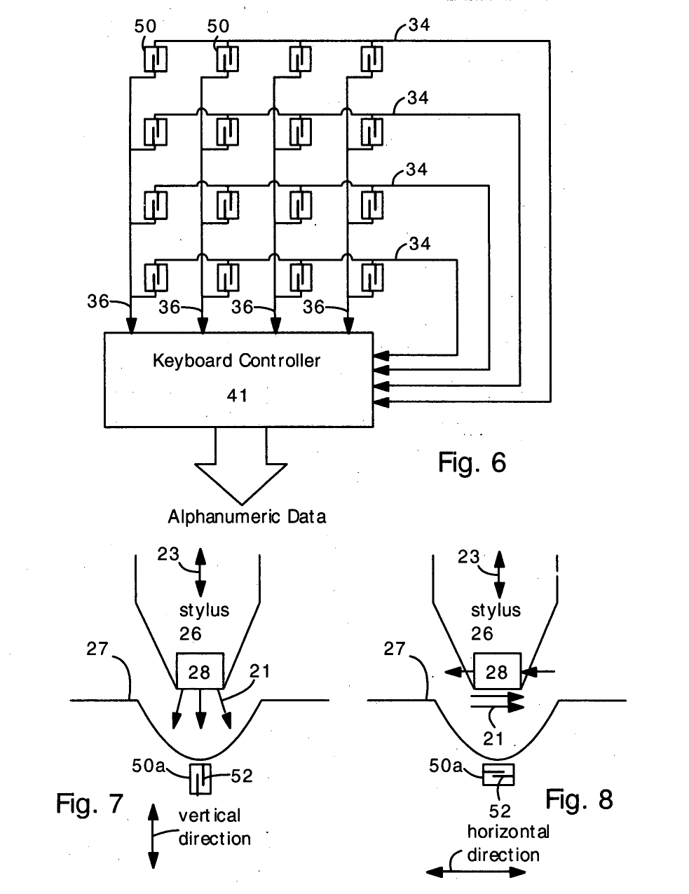

FIG. 3 shows a close-up view of the keyboard in an embodiment in which the proximity switches are reed switches. The reed switches 50a 50b 50c are connected in a matrix by row conductors 34 and column conductors 36 (see FIG. 6). The conductors 34 36 and reed switches 50a 56b 50c are disposed on a circuitboard 51.

Although the row conductor 34 is illustrated as being elevated above the circuitboard 51, it is noted that the row conductor 34 may be patterned on the circuitboard 51.

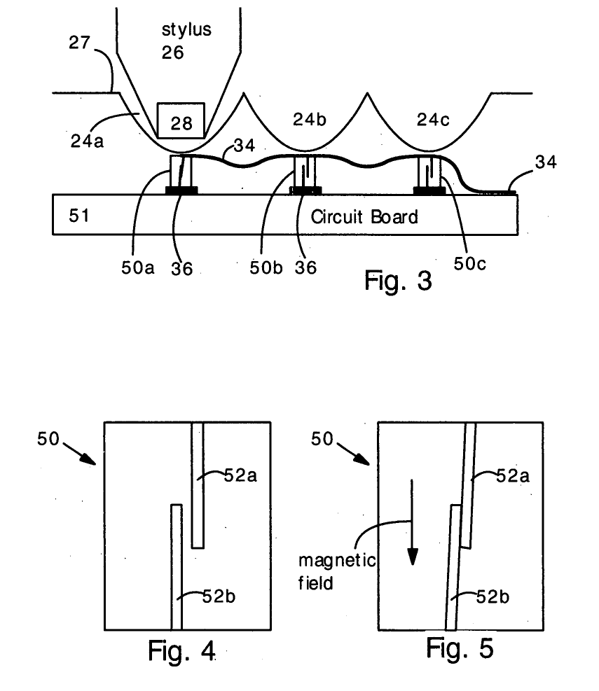

FIGS. 4 and 5 show closeup views of a magnetic reed switch. The reed switch 50 has two flexible ferromagnetic cantilevers 52a 52b. Preferably, the reed switch is filled with an inert gas and has a high reliability. In the absence of a magnetic field, the cantilevers 52a 52b are not in contact and there exists a very high electrical resistance between the cantilevers 52a 52b. When a magnetic field is applied, particularly a magnetic field oriented parallel with the cantilevers 52a 52b, a magnetic force causes the cantilevers to make electrical contact, as illustrated in FIG. 5. Hence, with a magnetic field applied, there is a relatively low resistance between the cantilevers 52a 52b. Magnetic reed switches are well known in the art.

Preferably, the reed switches 50 are very small and are made using micromachining techniques (e.g. lithographic patterning, thin film deposition, chemical etching and plasma etching). The magnetic reed switches can be about 1×1 mm or 2×2 mm or smaller in size, for example.

In FIG. 3, switch 50a is closed and has a low resistance due to the proximity of the stylus magnet 28. The switch 50a will remain closed as long as the stylus magnet 28 is located close to the switch 50a (e.g. located within the concave region 24a). Switches 50b 50c are not closed because the magnet 28 is relatively far away and the magnetic field is relatively weak near the switches 50b 50c. When the magnet 28 is located in the cocave region 24a, the magnetic field from the magnet 28 is not strong enough to cause the switches 50b 50c to close.

In the present invention, it is important for the sensitivity of the magnetic reed switches 50a 50b 50c and magnetic field strength of the magnet 28 to be selected such that the magnet 28 triggers only the selected reed switch (i.e. reed switch 50a). The stylus magnet 28 is preferably not so large or powerful as to cause adjacent, unselected switches 50b 50c to close. This assures that only one key of the keyboard will be selected when the stylus magnet 28 is disposed in one of the concave regions 24.

FIG. 6 shows magnetic reed switches 50 connected in a matrix array. When connected in a matrix array, the magnetic reed switches 50 can be electronically monitored in the same manner as conventional keyboards. Specifically, a keyboard controller (also known as a keyboard encoder) monitors rows 34 and columns 36 for a low resistance connection. Detection of a low resistance connection between a row and column indicates that a key has been selected. The keyboard controller 41 includes debouncing circuitry or software.

The magnetic reed switches 50 can have a vertical orientation, or a horizontal orientation. Generally, the reed switches are most sensitive to magnetic fields oriented parallel with the cantilevers 52. Typically, then, the stylus magnet 28 should be oriented to provide a vertical magnetic field when the cantilevers are vertical, and a horizontal magnetic field when the cantilevers are horizontal.

FIG. 7 illustrates an embodiment in which the reed switch 50 has a vertical orientation; the cantilevers 52 are oriented in the vertical direction. In this embodiment, the magnetic field 21 from the stylus magnet 28 should be oriented parallel with the stylus axis 23.

FIG. 8 illustrates an embodiment in which the reed switch 50 has a horizontal orientation; the cantilevers 52 are oriented in the horizontal direction. In this embodiment, the magnetic field 21 from the stylus magnet 28 should be oriented parallel with the stylus axis 23.

The vertical embodiment of FIG. 7 is generally preferred, because the rotational orientation (i.e. orientation about axis 23) does not need to be controlled. In the embodiment of FIG. 8, if the stylus is rotated about axis 23, then the reed switch might fail to respond to the magnetic field 21.

As noted above, the sensitivity of the reed switches should be controlled such that nonselected keys adjacent to a selected key are not triggered by the stylus magnet 28. The reed switches can have sensitivity tuned in many ways. For example, the stiffness of the cantilevers 52 can be increased to make the switch less sensitive, or the permeability of the cantilevers can be reduced to make the switch less sensitive. Alternatively, the strength and size of the magnet can be adjusted.

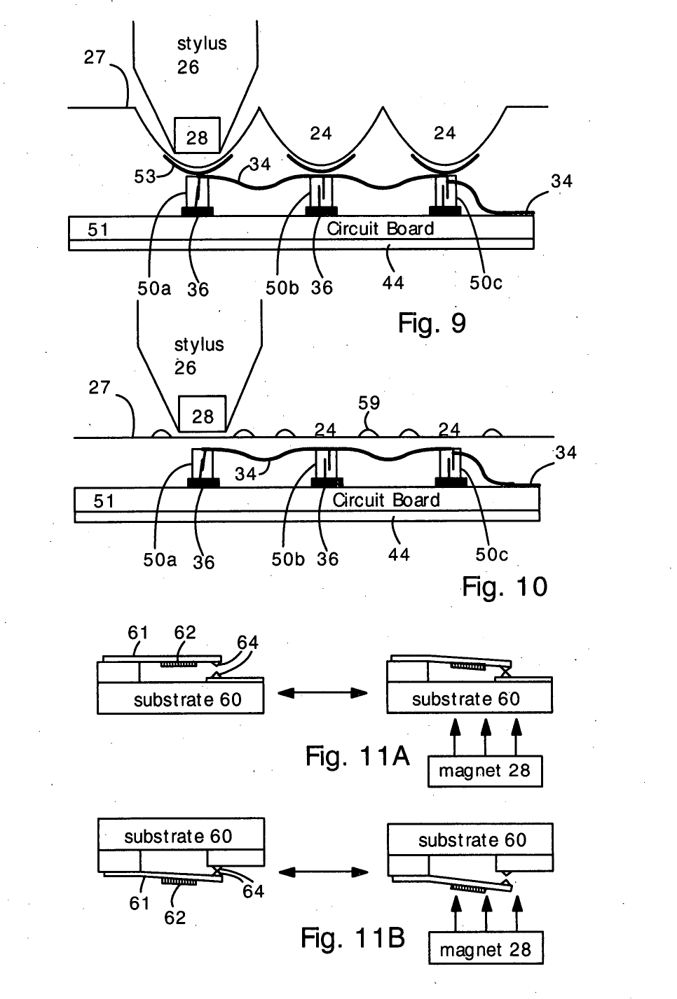

FIG. 9 shows another embodiment having a ferromagnetic layer 44 (e.g. comprising a mu-metal sheet or steel sheet) disposed under the reed switches 50. The ferromagnetic layer 44 will protect underlying electronic circuits and devices (not shown) from stray magnetic fields from the stylus magnet 28. Also, the ferromagnetic layer 44 will tend to concentrate the magnetic field at the selected reed switch 50a. Also in FIG. 9 an optional ferromagnetic yoke 53 is provided. The ferromagnetic yoke 53 tends to concentrate the magnetic field at the selected reed switch 50a.

FIG. 10 shows an embodiment where the concave regions 24 are defined by annular bumps or ridges 59. The bumps or ridges 59 help to guide the stylus tip into alignment with a single switch.

FIGS. 11A and 11B show two micromachined reed switches that can be used in the present invention. FIG. 11A shows a normally-open reed switch. The switch has a substrate 60, a cantilever 61, a ferromagnetic material 62, and contact points 64. With the magnet 28 near the reed switch, the cantilever 60 bends until the contact points 64 are in electrical contact.

FIG. 11B shows a normally-closed reed switch which can be used in the present invention. In the embodiment of FIG. 11B, the cantilever is biased so that the contacts 64 are normally in contact. With the magnet 28 near the reed switch, the cantilever bends so that the contacts 64 are separated.

The cantilever 60 can be made of micromachined single crystal silicon or polysilicon, for example. The ferromagnetic material 62 can comprise electrodeposited iron or iron-nickel alloy and the contacts 64 can be made of gold, for example. Methods of manufacturing micromachined reed switches are known in the art.

If normally closed reed switches are used (as illustrated in FIG. 11B), then the matrix detection scheme of FIG. 6 should not be used. The state of each switch can be detected individually (i.e. using individual wires for each switch). However, it is preferred in the invention to use normally open switches that close when exposed to a magnetic field.

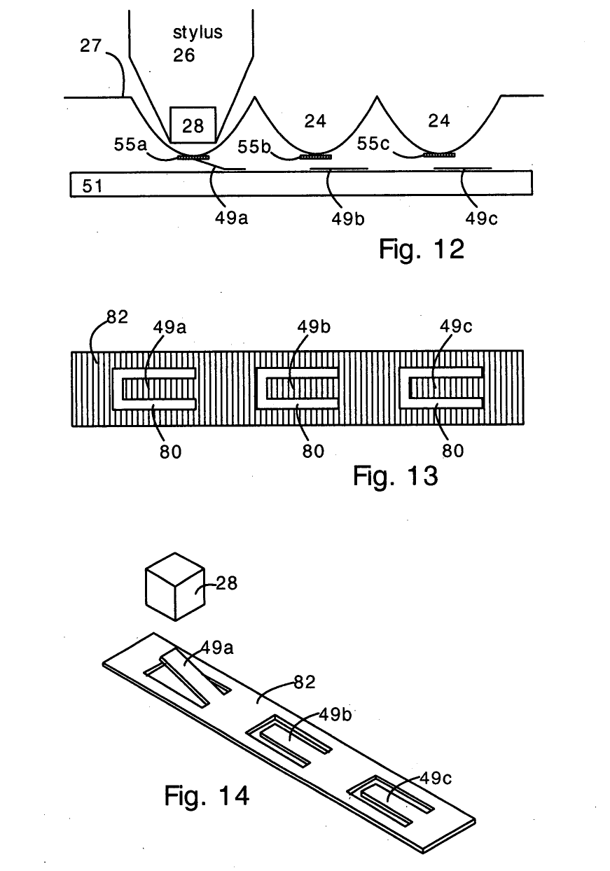

FIG. 12 shows a preferred embodiment in which each proximity switch comprises a flexible ferromagnetic conductive cantilever 49a 49b 49c. Stationary elevated electrodes 55a 55b 55c are provided above the cantilevers 49. The elevated electrodes 55 can be connected to row conductors (not shown), and cantilevers 49 can be connected to column conductors (not shown). Each cantilever 49a 49b 49c is sufficiently flexible and ferromagnetic (i.e. has a sufficiently high permeability) such that it is bent upwardly when attracted to the stylus magnet 28. For example, cantilever 49a is bent upwardly by attraction to the magnet 28. The cantilever 49a is in electrical contact with the elevated electrode 55a. An advantage of having flexible cantilevers as illustrated in FIG. 12 is that the switches will be thinner (compared to a keyboard having vertically aligned reed switches) and the present keyboard will require less volume.

In an alternative embodiment, elevated electrodes 55a 55b 55c comprise a conductive ink coating or metal film on the underside of the covering 27. The conductive ink coating can be applied in strips and can include carbon or silver particles for conductivity, as known in the art of conductive inks. Such conductive inks are commonly used in conventional keyboard membrane switches. Also, conductive inks or metal foils comprising the elevated electrodes can be disposed on a flexible circuit material (e.g., comprising polyimide film) adhered to the underside of the covering 27.

Preferably, the cantilevers 49 are made of a flexible and thin ferromagnetic material having a high permeability. These properties render the cantilevers easily bendable by the stylus magnet 28. For example, the flexible cantilevers can have a thickness of less than 0.001″, and a permeability of greater than 50,000.

In a preferred embodiment, the flexible cantilevers 49a 49b 49c are made of a metallic glass (i.e., a metal alloy with an amorphous crystal structure). Specifically, the cantilevers can comprise a metallic glass made of cobalt (75-90%), iron (7-13%), silicon (7-13%), boron (1-5%) and nickel (1-5%) (other ferromagnetic alloy compositions can also be used). With this material, the cantilevers can have a thickness of about 0.0004-0.0008 inches (or 0.0001-0.0015 inches), and a magnetic permeability in the range of about 100,000 to 1 million, or 250,000 to 1 million (in a DC field), or more. Cantilevers made of metallic glasses are preferred, but not essential, in the invention. Ferromagnetic metallic glasses can have high resiliency, high fatigue resistance, and high permeability, which are desirable properties for the flexible cantilevers. However, it is noted that nonamorphous (i.e. crystalline) ferromagnetic foils (e.g. mu-metal foil) can also be used. Also, the flexible cantilevers 49 can comprise non-ferromagnetic resilient material (e.g. such as a polymeric elastomer) with a conductive portion (e.g., conductive ink or metal foil) and a ferromagnetic portion (e.g., steel sphere) attached.

FIG. 13 shows a top view of a monolithic metal foil strip 82 comprising 3 flexible cantilevers 49a 49b 49c. The cantilevers 49a 49b 49c can easily bend in a direction perpendicular to the page. Preferably, the metal foil 82 is a cobalt-iron-silicon-boron-nickel metallic glass (as described above) with a thickness less than 0.001 inches. U-shaped cut-out regions 80 define the flexible cantilevers 49a 49b 49c. The cut-out regions 80 can be created by photochemical etching (a preferred method), laser cutting or other material removal techniques. Each keyboard can have 3 or 4 metal foil strips; with each strip having 8-10 flexible cantilevers 49, for example. For example, a 40-key keyboard can be made using 4 strips with each strip having 10 flexible cantilevers. Also, it is noted that the metal foil strips can be curved instead of straight. Curved strips can be used to make curved or arc-shaped keyboards.

FIG. 14 shows a perspective view of the metal foil strip 82 and stylus magnet 28 in isolation. The stylus magnet 28 is located directly over the flexible cantilever 49a, and pulls the cantilever 49a upwardly. The other flexible cantilevers 49b 49c are far from the stylus magnet 28 and so remain in the plane of the metal foil strip 82.

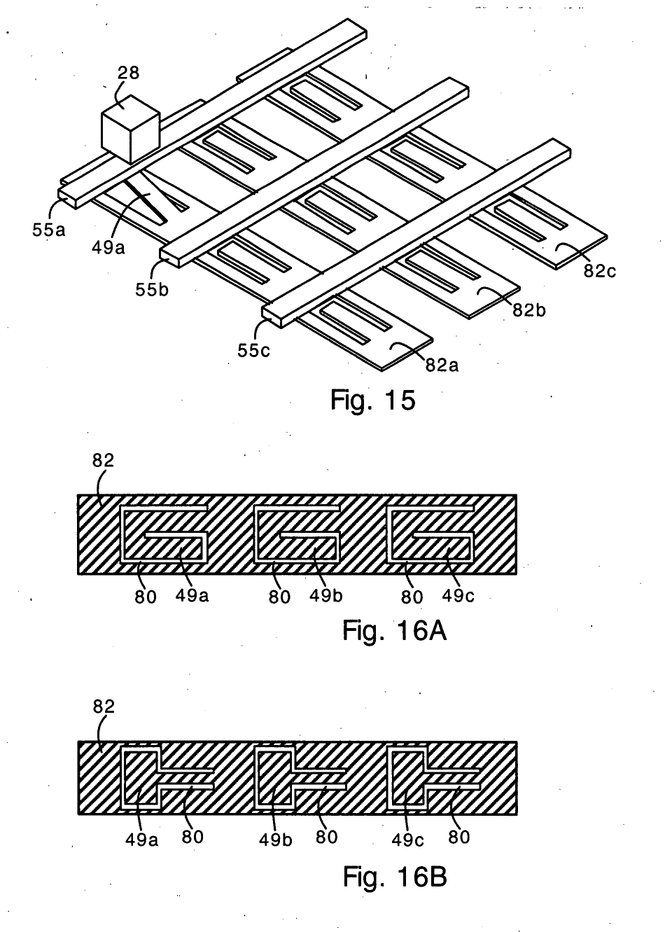

FIG. 15 shows a perspective view of a 3×3 proximity switch array according to the present invention. For clarity, the covering 27 and concave regions 24 are not shown, though they may be present. The switch array includes 3 metal foil strips 82a 82b 82c. Each metal strip has three flexible cantilevers. The cantilevers can be about 0.025-0.200 inches long, for example. Elevated electrodes 55a 55b 55c are disposed above the flexible cantilevers (e.g. about 0.010 to 0.050 inches above the cantilevers 49) and extend in a direction perpendicular to the metal strips 82a 82b 82c. In a preferred embodiment, the metal foil strips 82a 82b 82c function as row (or column) conductors, and the elevated electrodes function as column (or row) conductors (i.e., in the switch detection scheme illustrated in FIG. 6). In the example of FIG. 15, the stylus magnet 28 pulls the flexible cantilever 49a upwardly so that it is electrically connected to the elevated electrode 55a. All other flexible cantilevers are unaffected by the stylus magnet 28. It is noted that a full-function keyboard may comprise a 4×10 or 5×10 array of switches, for example.

FIG. 16A shows an alternative embodiment in which the flexible cantilevers 49a 49b 49c are U-shaped.

FIG. 16B shows an alternative embodiment in which the flexible cantilevers have a large free end, and a narrow base. The large free end increases the magnetic attraction force, and the narrow base reduces the force required for bending. In the embodiment of FIG. 16B, the metal foil comprising the strip 82 can have a relatively large thickness because the cantilevers 49 are more easily bent by the magnet 28.

Also, it is noted that the metal foil strips 82, elevated electrodes 55 and other components can be gold plated to prevent the formation of insulating metal oxides.

Also, it is noted that the flexible cantilevers can be provided as separate parts for each switch (i.e., the cantilevers do not need to be part of a monolithic metal strip 82). For example, each switch can have a separate flexible cantilever that is glued, soldered or spot-welded to the circuitboard 51. The cantilevers do not need to be connected in a monolithic metal foil strip 82.

Also, it is noted that a weak return magnet (not shown) can be disposed within or underneath the circuit board 51. The return magnet pulls downwardly on the flexible cantilevers 49 and causes them to return to an unbent, open position when the stylus magnet 28 is removed.

In another aspect of the present invention, a selected key is detected by a change in capacitance. In this embodiment, the flexible cantilevers 49 and electrodes 55 do not need to form a low resistance contact. When a key is selected, the flexible cantilever 49 is moved very close to the corresponding electrode 55 (e.g. separated only by a very thin insulating film), resulting in a large increase in capacitive coupling.

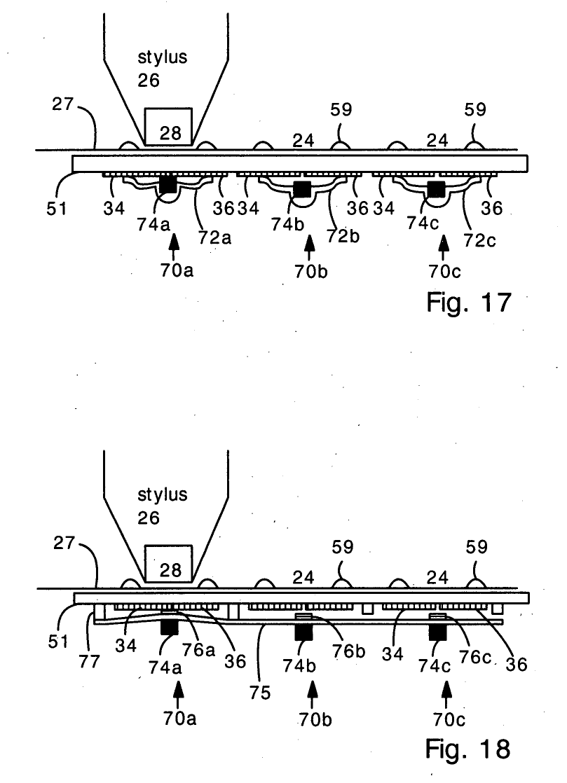

FIG. 17 shows an alternative embodiment having magnetic membrane switches 70a 70b 70c. The membrane switches each have flexible elastomeric membranes 72a 72b 72c. A separate membrane can be provided for each switch, as illustrated in FIG. 16, or a single monolithic membrane can be provided for all the switches 70a 70b 70c. Attached to the membranes 72a 72b 72c are ferromagnetic elements 74a 74b 74c. The ferromagnetic elements 74 can move in the vertical direction by flexing of the membranes 72. A top surface of each ferromagnetic element (or, alternatively, a top surface of each membrane 72) is electrically conductive. Each ferromagnetic element 74a 74b 74c can be a particle of iron or iron-nickel alloy, or can be magnetized.

In operation, the stylus magnet 28 is moved close to a selected switch (i.e. switch 70a). Ferromagnetic element 74a is attracted to the magnet 28, and moves upward until it contacts the conductors 34 36. The ferromagnetic element 74a provides an electrical connection between the conductors 34 36. In an alternative embodiment, the membranes 72 each have a conductive upper surface (e.g. coated with a carbon-containing paint), and the ferromagnetic element 74a presses the conductive upper surface against the conductors 34 36. When the stylus magnet 28 is moved away from switch 70a, the membrane 72a returns to its former position, and the switch opens.

The ferromagnetic elements 74a can be magnets oriented such that they are attracted to the stylus magnet 28. The ferromagnetic elements can also be small steel or mu-metal objects, such as small steel spheres.

FIG. 18 shows an alternative embodiment in which the ferromagnetic elements 74a 74b 74c are supported on a continuous flexible elastomeric sheet 75. The sheet 75 is supported by posts located between the switches. Conductive pads 76a 76b 76c are aligned with the ferromagnetic elements 74a 74b 74c. In operation, the stylus magnet 28 attracts the ferromagnetic element 74a, causing the elastomeric sheet 75 to bend until the conductive pad 76a contacts the conductors 34 36, thereby closing the switch.

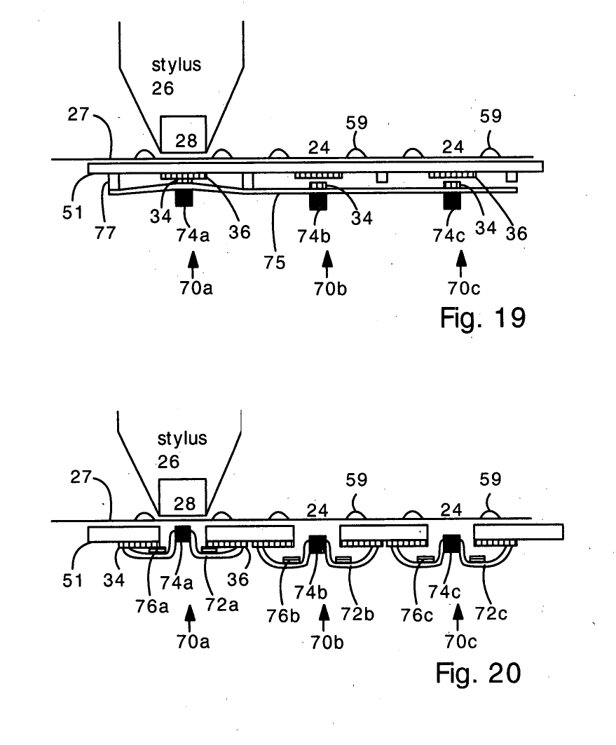

FIG. 19 shows an alternative embodiment in which row conductors 34 are disposed on the elastomeric membrane 75. The row conductors can comprise strips of electrically conductive ink having carbon or silver particles.

FIG. 20 shows an alternative embodiment in which the ferromagnetic elements are located closer to the stylus magnet 28. In this embodiment, holes in the circuitboard 51 are provided for the ferromagnetic elements 74. The element 74 pulls the membrane 72 into the hole, until the conductive pads 76a contact the conductors 34 36. An advantage of the switch of FIG. 19 is that the ferromagnetic elements 74 can experience a high attractive force to the magnet 28.

Preferably, the elastomer comprising the membranes 72a 72b 72c and sheet 75 is a very soft elastomer such as a soft silicone (e.g. having a hardness of Shore A 5, 10, 20, or 40). A soft, easily bendable elastomer is preferred in the invention because the stylus magnet 28 and ferromagnetic elements 74 will typically be very small (e.g. 1×1 mm or 2×2 mm), and hence will produce a small force on the ferromagnetic elements 74.

FIGS. 17-20 show four examples of magnet-actuated membrane switches. Many other variations are possible. For example, the flexible elastomer can be in the form of a cantilever. Also, it is noted that the magnet-actuated membrane switches can be connected in a matrix array, as well known in the art of keyboard electronics.

The magnetic membrane switches 70 are very similar to conventional membrane switches with the exception that the switches are actuated by an attractive magnetic force from a handheld magnet, instead of a compressive force from a users finger.

In the present invention, the reed switches of FIGS. 3-10, flexible cantilever switches of FIGS. 11A-16B, and membrane switches of FIGS. 17-20 are examples of magnet-actuated switches. In the present invention, a magnet-actuated switch is a mechanical device that creates or breaks and electrical connection when a magnetic field is applied. Preferably, an electrical connection is created when a magnetic field is applied to the switch. The reed switches, flexible cantilever switches and membrane switches described in the present specification are specific examples of magnet-actuated switches. Other kinds of magnet-actuated switches may be designed for use in the present invention, provided that the magnetic switch creates or breaks an electrical connection when the stylus magnet is moved into proximity to the switch. Other kinds of magnet-actuated switches not specifically described herein are within the scope of the present invention and appended claims.

The present keyboard device can be provided as a stand-alone keyboard module. The keyboard module can communicate wirelessly (e.g., via a Bluetooth link) with other electronic devices, or can have a conventional wired (e.g. USB or serial) connector for mating with other devices.

Magnetic field sensing devices such as Hall effect sensors and magnetoresistive sensors are not magnet-actuated switches as defined in the present specification and appended claims. These magnetic sensors are excluded from the scope of the claims. Hall effect sensors and magnetoresistive sensors require a power-draining bias current, and are therefore impractical for use in portable electronic devices.

The present invention provides a small size and low power keyboard that can be used in many alphanumeric input applications. The present invention is particularly well suited for use in portable electronic devices because of its small size, low power consumption, lack of mechanical moving parts. Also, the present invention provides the additional benefit of not requiring pressing of the stylus, which makes typing faster and reduces user fatigue and injury.

It will be clear to one skilled in the art that the above embodiment may be altered in many ways without departing from the scope of the invention. Accordingly, the scope of the invention should be determined by the following claims and their legal equivalents.

What is claimed is:

1. A keyboard, comprising:
a) a plurality of keyboard keys;
b) at least one magnet-actuated switch disposed under each keyboard key.
c) a magnet for causing a magnet-actuated switch under a selected key to change state when the magnet is disposed near the selected key.

2. The keyboard of claim 1, wherein each magnet-actuated switch comprises:
1) an elevated electrode; and
2) a flexible, ferromagnetic and conductive cantilever bendable by attraction to the magnet such that the cantilever makes electrical contact with the elevated electrode when the magnet is disposed near the selected key.

3. The keyboard of claim 2, wherein the flexible conductive cantilevers comprise a ferromagnetic metal foil with a thickness in the range of 0.0001 to 0.002 inches.

4. The keyboard of claim 3, wherein a plurality of cantilevers are portions of a single monolithic strip of ferromagnetic metal foil.

5. The keyboard of claim 3, wherein the cantilevers comprise a metallic glass.

6. The keyboard of claim 1, further comprising a stylus, wherein the magnet is disposed at a tip of the stylus.

7. The keyboard of claim 1, wherein a strength of the magnet and a sensitivity of the magnet-actuated switches are selected such that only the single selected key is activated by the magnet when the magnet is disposed over the selected keyboard key.

8. The keyboard of claim 1, further comprising a covering disposed over the magnet-actuated switches, wherein the covering has a concave region aligned over each magnet-actuated switch, and each concave region corresponds to a keyboard key.

9. The keyboard of claim 1, wherein the magnet-actuated switches are reed switches

10. The keyboard of claim 1, wherein the magnet-actuated switches are membrane switches.

11. A portable electronic device, comprising:
a) a display;
b) a plurality of keyboard keys;
c) at least one magnet-actuated switch disposed under at least one keyboard key;
d) an external shell of the portable electronic device covering the switches;
e) a magnet, external to the portable electronic device, for causing the magnet-actuated switch under a selected key to change state when the magnet is disposed near the selected key.

12. The portable electronic device of claim 11, wherein each magnet-actuated switch comprises:
1) an elevated electrode; and
2) a flexible, ferromagnetic and conductive cantilever bendable by attraction to the magnet such that the cantilever makes electrical contact with the elevated electrode when the magnet is disposed near the selected key.

13. The portable electronic device of claim 12, wherein the flexible conductive cantilevers comprise a ferromagnetic metal foil with a thickness in the range of 0.0001 to 0.002 inches.

14. The portable electronic device of claim 13, wherein a plurality of cantilevers are portions of a single monolithic strip of ferromagnetic metal foil.

15. The portable electronic device of claim 12, wherein the cantilevers comprise a metallic glass.

16. The portable electronic device of claim 11, further comprising a stylus, wherein the magnet is disposed at a tip of the stylus.

17. The portable electronic device of claim 11, wherein a strength of the magnet and a sensitivity of the magnet-actuated switches are selected such that only the single selected key is activated by the magnet when the magnet is disposed over the selected keyboard key.

18. The portable electronic device of claim 11, further comprising a covering disposed over the magnet-actuated switches, wherein the covering has a concave region aligned over each magnet-actuated switch, and each concave region corresponds to a keyboard key.

19. The portable electronic device of claim 11, wherein the magnet-actuated switches are reed switches

20. The portable electronic device of claim 11, wherein the magnet-actuated switches are membrane switches.

21. A keyboard, comprising:
a) a plurality of keyboard keys;
b) at least one magnet-actuated switch disposed under each keyboard key;
c) a magnet for causing a magnet-actuated switch under a selected key to change state when the magnet is disposed near the selected key;
wherein each magnet-actuated switch comprises:
1) an elevated electrode; and
2) a flexible, ferromagnetic and conductive cantilever bendable by attraction to the magnet such that the cantilever makes electrical contact with the elevated electrode when the magnet is disposed near the selected key.

22. The keyboard of claim 21, wherein the flexible conductive cantilevers comprise a ferromagnetic metal foil with a thickness in the range of 0.0001 to 0.002 inches.

23. The keyboard of claim 22, wherein a plurality of cantilevers are portions of a single monolithic strip of ferromagnetic metal foil.

24. The keyboard of claim 21, wherein the cantilevers comprise a metallic glass.

25. The keyboard of claim 21, further comprising a stylus, wherein the magnet is disposed at a tip of a stylus.
